(19) United States
(12) Patent Application Publication
(10) Pub. No.: US 2026/0189915 A1
(43) Pub. Date: Jul. 2, 2026

(54) BRIDGE INTERFACE FOR SECURE ELEMENT

(71) Applicant: Apple Inc., Cupertino, CA (US)

(72) Inventors: Paul B. FRUHAUF, Santa Clara, CA (US); Catalin GIURCA, San Francisco, CA (US); Rahul Narayan SINGH, Santa Clara, CA (US)

(21) Appl. No.: 19/085,992

(22) Filed: Mar. 20, 2025

Related U.S. Application Data
(60) Provisional application No. 63/739,111, filed on Dec. 26, 2024.

(51) Int. Cl. H04W 12/50; H04W 64/00; H04W 76/12

(52) U.S. Cl. CPC H04W 12/50; H04W 64/00; H04W 76/12

(57) ABSTRACT

The subject system may be implemented to establish a secure session between a first device and a second device over a first protocol. Data is sent to the first device from the second device over the first protocol. The first device receives the data and emulates a second protocol to send the data to an application in a secure element in the first device. The application responds over the second protocol and the first device transmits the response over the first protocol back to the first device.

### CROSS REFERENCE TO RELATED APPLICATIONS

This application claims the benefit of U.S. Provisional Application No. 63/739,111, entitled “BRIDGE INTERFACE FOR SECURE ELEMENT,” filed December 26, 2024, the entirety of which is incorporated herein by reference.

### TECHNICAL FIELD

The present description generally relates to digital credentials on electronic devices and, more particularly, to the use of digital credentials on electronic devices based on receiving a signal over a first interface and processing the signal as if received on a second interface.

### BACKGROUND

A digital credential is an electronic version of a physical credential, often used for identification, access, or payment purposes. The digital credential may be stored on a digital wallet of a smartphone, computer, or other electronic device and used in place of physical credentials, such as ID cards, credit cards, or membership cards. The type of information and/or access provided by a digital credential may include simple identification and authentication to more complex entitlements and payments, such as credit card payments or other services. Information corresponding to a digital credential may be represented by an identifier, such as a token, device number, and/or the like, which may be presented for use, for example, as an image, sound, code, signal, and/or the like.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment for validating a digital credential, in accordance with one or more implementations.

FIG. 2 depicts an example electronic device that may implement the subject methods and systems, in accordance with one or more implementations.

FIG. 3 depicts an example secure element, in accordance with one or more implementations.

FIG. 4 depicts an example electronic system including a device and terminal that may implement the subject methods and systems, in accordance with one or more implementations.

FIG. 5 depicts an example validation process using tunnelling, in accordance with one or more implementations.

FIG. 6 depicts an example validation process using a channel-less interface, in accordance with one or more implementations.

FIG. 7 depicts a flow diagram of an example process for establishing a bridge interface to validate an access credential, in accordance with one or more implementations.

FIG. 8 depicts an example electronic system with which aspects of the present disclosure may be implemented, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A digital credential is a form of electronic verification used to authenticate and verify the identity of the holder through digital means, enabling secure access to services, resources, or information. A digital credential encompasses a wide array of digital entities, including but not limited to digital payment cards and digital access cards, which can be integrated into digital wallets of devices such as smartphones for NFC-based payments and authentication. Digital credentials may be encoded with information that identifies and confirms the legitimacy of the holder, utilizing cryptographic methods for data integrity and security. Unlike physical credentials, digital credentials offer a more convenient and efficient means of carrying and presenting proof of identity, eligibility, or authority, facilitating seamless transactions and interactions in various domains, from financial transactions to secure access to online services.

When a digital credential is used, a secure element in a host device is used to provide information exchanged over an interface established between the host device and a receiver device. In the case of an NFC-based exchange, for example, a user of the host device can activate an NFC system in the device so that when the user brings the device into proximity of an NFC reader, an interface can be established between the host device and the receiver over an NFC radio transmission. The secure element of the host device can send and receive information over the interface. Emerging technologies require secure data exchange processing over various interfaces involving the secure element chip. The secure element may have different I/O interfaces associated therewith, such as a wired interface, radio interface, NFC interface, ultra-wideband (UWB) interface, and Bluetooth interface. As a measure of additional security, applications operating in the secure element may be programmed to only function over specified interfaces. For example, a particular application running in the secure element may only respond to requests over the NFC interface. Or, for example, wireless credential applications can use proximity information securely over the UWB interface. The applications using the secure element practice security, for example, by allowing and/or disallowing functionality depending on the interface over which it is accessed. Thus, there is generally no mechanism to allow an attempted use of a digital credential over a first interface (UWB, for example) for an application expecting the use over a second interface (NFC, for example). Further, even within a particular interface, different versions of communication protocols may be similarly applied to only allow the use of a digital credential over a first interface using a particular communications protocol.

The subject technology provides flexibility by using previously deployed applications in secure elements with alternate communications interfaces and without having to replace infrastructure to achieve such flexibility. The subject technology implements a virtual communication interface (VCI) (also referred to as a bridge interface) to interact with a terminal device to establish a secure session. The bridge interface can be implemented to support up to all available communication interfaces on an electronic device, and forward APDUs received over one interface to another interface within the secure element. In some implementations, however, the bridge interface may be limited to rejecting data from a contactless interface, such as a WiFi interface. Aspects of the subject technology can achieve this by tunnelling the APDUs to a hardware controller for the target interface so that the hardware controller receives the APDUs logically as if they were provided directly to the hardware controller via a corresponding hardware interface. This advantageously allows for quicker deployment because it can leverage existing secure element programming modules, while still being compliant with security standards, for example, as implemented by GlobalPlatform. Applications can opt-in or opt-out of the ability to use the bridge tunnelling. Further, applications can allow certain commands over the bridge tunnelling while other commands may not be available via the bridge tunnelling.

In another aspect of the subject technology, forwarding the APDUs can be achieved by establishing a pure virtual interface (referred to as a channel-less interface) (e.g., not requiring an established hardware to hardware communication channel) that can forward APDUs directly to applications within the secure element. While applications in the secure element may need to be modified to accept a pure virtual connection (e.g., in addition to another type of physical connection), such changes can further simplify future deployment of new communication technologies and/or protocols. In implementations using a channel-less bridge, applications can allow certain commands over the channel-less bridge, while restricting other commands from being available via the channel-less bridge.

As an example, in a non-limiting use case of the subject technology, suppose a user stores a digital access credential, such as an access card, on their smartphone to tap on a reader at a door at a facility to unlock the door. So rather than use the physical access card, the user can use their smartphone to tap to unlock the door. When the user taps, a communications session is established between the phone and the reader, the reader gets the access credential information from the phone and, for example, submits it to a server to determine if the access credential is valid and if it is authorized to open the door associated with the reader. A determination is made that the access credential is valid and authorized, and the door is unlocked. Now, if the facility were to implement a UWB proximity technology, with the idea that as a user approaches the door the presence of the smartphone in proximity to the door can automatically cause the door to unlock, typically each of the user’s smartphones would have to be upgraded to allow it to use a new access credential associated with the UWB to establish a secure session to unlock the door. The subject technology solves this concern by enabling the smart phone to use the same tap program functionality in the secure element, except over the UWB interface by tunnelling the data to an interface controller for the tap interface. In such a manner, the tap software handler (i.e., applet as described below) can be allowed to respond over its normal interface which is then tunneled to an interface other than the normal interface. This makes provisioning an upgrade to a digital access system easier to deploy as it limits the upgrades to simply providing a communications interface which the electronic device 110 already supports.

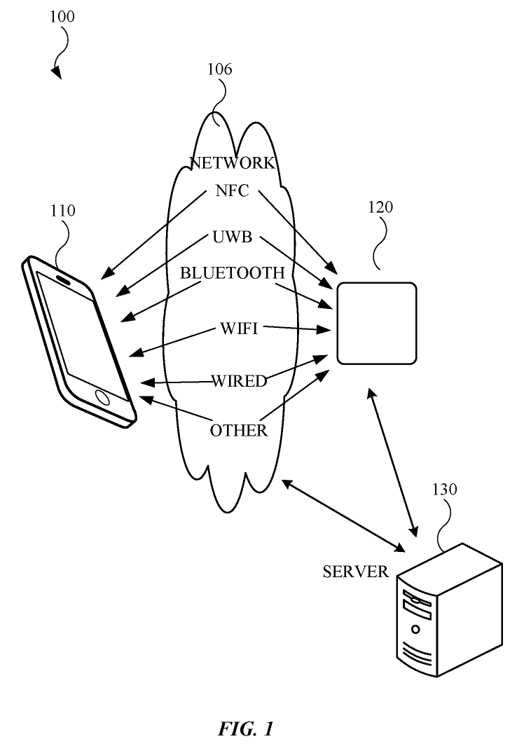

FIG. 1 illustrates an example network environment 100 for utilizing a digital credential, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include an electronic device 110, an electronic device 120, and one or more provider servers 130 (referred to as provider server 130). The network 106 may communicatively (directly or indirectly) couple the electronic device 110, the electronic device 120, and/or the provider server 130. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 120, and the provider server 130; however, the network environment 100 may include any number of electronic devices and/or any number of servers communicatively coupled to each other directly or via the network 106.

More particularly, the network environment 100 may include the electronic device 110 having a stored credential thereon; the electronic device 120 which may include a reader device or terminal device to read the stored credential, validate the stored credential, and perform an action based on the stored credential; and the provider server 130 which may be in communication with the electronic device 110 and or the electronic device 120, for example, to provide data related to the validation of the stored credential or interface with the electronic device 120 to receive a request to perform an action. As illustrated in FIG. 1, the network 106 may include any number of networking technologies, including the aforementioned Internet related communication technologies. The networking technologies can further include peer-to-peer communication technologies, such as near-field communications (NFC) interfaces, ultra-wideband (UWB) interfaces, Bluetooth interfaces, wireless (e.g., WiFi) interfaces, wired interfaces, or other communications interfaces (e.g., infrared, etc.). The networking technologies of the network 106, for example, can be used to establish a secure connection between the electronic device 110 and the electronic device 120 for the electronic device 110 to provide to the electronic device 120 a representation of its stored credential.

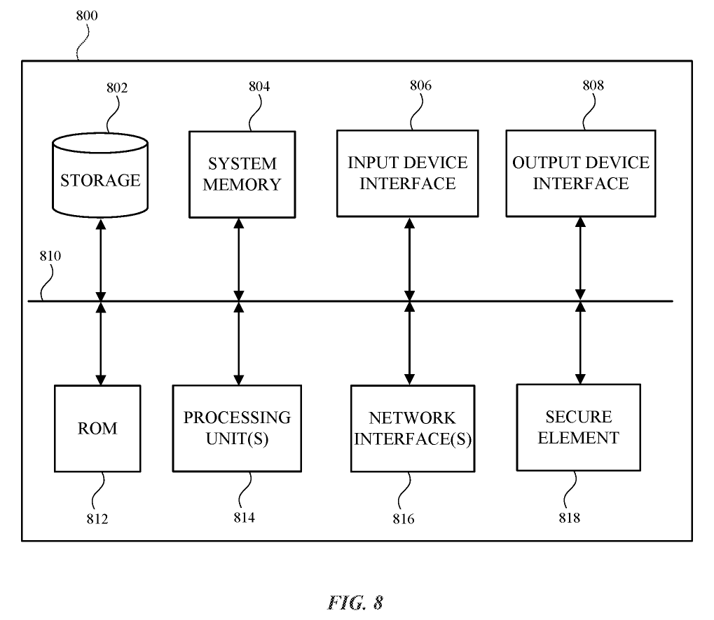

The electronic device 110 may be, for example, a wearable device such as a watch, a band, and the like, a desktop computer, a portable computing device such as a laptop computer, a smartphone, a peripheral device (e.g., a digital camera, headphones), a tablet device, or any other appropriate device that includes, for example, one or more wireless interfaces, such as WLAN radios, cellular radios, UWB radios, Bluetooth radios, Zigbee radios, near-field communication (NFC) radios, and/or other wireless radios. In FIG. 1, by way of example, the electronic device 110 is depicted as a smartphone. The electronic device 110 may be, and/or may include all or part of, the electronic system discussed below with respect to FIG. 8.

The electronic device 110 may include one or more digital wallet applications and one or more digital credentials. The electronic device 110 may also be associated with a user account. For example, the electronic device 110 may be registered to a user account associated with the electronic device 120 and/or provider server 130. The electronic device 110 may also include an NFC reader and/or transmitter, enabling the electronic device 110 to interact with other NFC-enabled devices or objects within a close range, such as a few centimeters. In the case of an NFC reading operation, when activated, the NFC reader may generate an electromagnetic field that powers an NFC tag, allowing for the transfer of data such as payment information, digital identification cards, or smart home commands. In the case of an NFC transmitter operation, when activated, the NFC transmitter can be powered by an NFC reader or can provide its own power to activate an NFC field to allow the electronic device 110 to transmit information over the NFC field. Digital exchange of information utilizing the NFC reader and/or transmitting may be secured through encryption and tokenization, so that sensitive information is protected during transactions. Similar transactions may be undertaken on wired interfaces, wireless interfaces, and so forth.

The electronic device 120 may be, for example, a wearable device such as a watch, a band, and the like, a desktop computer, a portable computing device such as a laptop computer, a smartphone, a peripheral device (e.g., a digital camera, headphones), a tablet device, or any other appropriate device that includes, for example, one or more wireless interfaces, such as WLAN radios, cellular radios, UWB radios, Bluetooth radios, Zigbee radios, near-field communication (NFC) radios, and/or other wireless radios. In FIG. 1, by way of example, the electronic device 120 is depicted as a terminal. The electronic device 120 may be, and/or may include all or part of, the electronic system discussed below with respect to FIG. 8.

The electronic device 120 may be configured to determine if an attempt to verify an access credential is performed by the electronic device 110. The electronic device 120 may be associated with the provider server 130 and/or have a registered user account associated with the electronic device 110 contained thereon. The electronic device 120 may also include an NFC reader and/or transmitter, enabling the electronic device 110 to interact with other NFC-enabled devices or objects within a close range, such as described above. The electronic device 120 may further be configured to include the ability to exchange authentication data over other communications protocols. For example, if the electronic device 120 is a smart home device or smart automotive device, UWB can be used to verify location of the electronic device 110 relative to the electronic device 120 and an access credential can be sent over UWB between the electronic device 110 and electronic device 120, causing, for example, the electronic device 120 to unlock a door, start an automobile, or disable an alarm system, and so forth. Aspects of the subject technology, for example, can provide that an exchange of an access credential over one communications protocol be processed as if provided over another communications protocol.

The provider server 130 may facilitate interactions between the electronic device 110 and various online services or resources via the electronic device 120. Operating within a networked environment (e.g., network 106), the provider server 130 may be owned and/or operated by a security access network, payment network, or other credential issuer. The provider server 130 may include one or more applications, applets, or other software processes for receiving and verifying access credentials (e.g., associated with a security system access or a payment credential). Upon completion, the provider server 130 may generate a response that may include an indication about the validity of the access credential. For example, when an access credential is stored at the electronic device 110, e.g., in a secure element of the electronic device 110, and a user activates a program (e.g., a digital wallet) on the electronic device 110 to present the access credential through a contactless interaction with the electronic device 120, the electronic device 120 may validate the access credential and, if appropriate, transmit the data to the provider server 130 to register a transaction between the two devices, such as logging a tap event and the associated and transmitted tap data, which, in the case of a payment, may include encrypted information unique to the access credential (e.g., digital payment card), such as, a dynamic cryptogram. The tap data may undergo a validation process at the provider server 130 to determine, e.g., the legitimacy of the access credential and a user’s identity associated with the electronic device 110. The provider server 130 may also contain applications or other programmatic functions to register the access credential at the electronic device 110 for initial use.

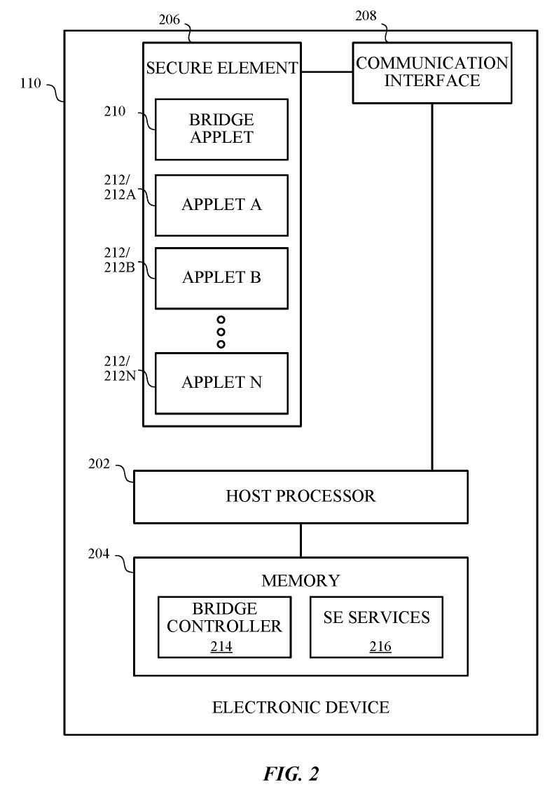

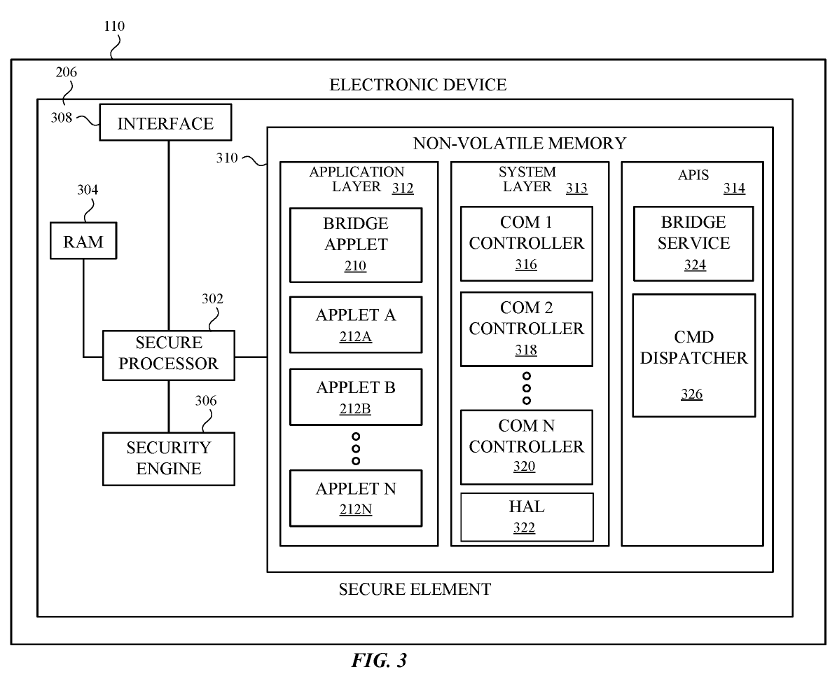

FIG. 2 depicts an overview of example electronic device 110 that may implement the subject methods and systems, in accordance with one or more implementations. For explanatory purposes, FIG. 2 is primarily described herein with reference to the electronic device 110 of FIG. 1. However, this is merely illustrative, and features of the electronic device of FIG. 2 may be implemented in any other electronic device for implementing the subject technology. Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided. In particular, additional details of the example electronic device 110 are illustrated in FIG. 3.

The electronic device 110 may include one or more of a host processor 202, a memory 204, a secure element 206, and/or a communication interface 208. The host processor 202 may include suitable logic, circuitry, and/or code that enable processing data and/or controlling operations of the electronic device 110. In this regard, the host processor 202 may be enabled to provide control signals to various other components of the electronic device 110. The host processor 202 may also control transfers of data between various portions of the electronic device 110. The host processor 202 may further implement an operating system or may otherwise execute code to manage operations of the electronic device 110.

The memory 204 may include suitable logic, circuitry, and/or code that enables storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). In one or more implementations, the memory 204 may store applications and application data (e.g., digital credentials). The memory 204 may include program modules stored thereon which are executed by the host processor 202. The memory 204 may include, for example, a bridge controller 214 and a secure element services module 216. Each module may include code which when executed by the host processor 202 performs a series of operations. The secure element services module 216 can be used to establish a secure session between the electronic device 110 and the electronic device 120. The bridge controller 214 can be used to process communications received over a communications interface 208 via the secure session and forward it to the bridge applet in the secure element 206, which can set up tunnelling or a channel-less interface. For example, the bridge controller 214 corresponds to a system program off of the secure element that can receive data over a first interface and forward it to the bridge applet 210, as explained in greater detail below.

The communication interface 208 may include suitable logic, circuitry, and/or code that enables wired or wireless communication, such as between the electronic device 110 and the provider server 130. The communication interface 208 may include, for example, one or more of a Bluetooth communication interface, an NFC interface, a UWB communication interface, a Zigbee communication interface, a WLAN communication interface, a universal serial bus (USB) communication interface, a cellular interface, or generally any communication interface. In some implementations, the communication interface 208 may include an NFC controller including one or more antennas and one or more transceivers for transmitting/receiving NFC communications. The NFC controller may further include one or more interfaces, such as a single wire protocol interface, for coupling to the host processor 202 and/or the secure element 206. The NFC controller may be able to communicate via one or more different NFC communication protocols, such as NFC-A (or Type A), NFC-B (or Type B), and/or NFC-F (or Type F or FeliCA). The NFC-A protocol may be based on International Organization for Standardization (ISO)/International Electrotechnical Commission (IEC) 14443A and may use Miller bit coding with a 100 percent amplitude modulation. The NFC-B protocol may be based on ISO/IEC 14443B and may use variations of Manchester encoding along with a 10 percent modulation. The NFC-F protocol may be based on FeliCA JIS X6319-4 and may use a slightly different variation of Manchester coding than the NFC-B protocol. Power may be supplied to the NFC controller and the secure element 206 from a current induced by a wireless reader, such as an NFC reader of a payment terminal. Thus, in one or more implementations, the NFC controller and the secure element 206 may be able to present digital credentials even when the electronic device 110 is unable to supply power to the NFC controller and/or the secure element 206.

The secure element 206 may include hardware that provides secure storage and management of sensitive information. The secure element 206 may be securely isolated from the host processor 202 and operating system, making it more difficult for unauthorized access. The secure element 206 may be used for secure transactions and/or identification, such as payment credentials, digital passes, and the like. The secure element 206 may store sensitive information, such as cryptographic keys or digital credentials, and may protect the sensitive information with cryptographic algorithms and access controls. For example, the secure element 206 may include a hardware specific private key that is provisioned on the secure element 206 at or near the time of manufacture. The use of the secure element 206 provides an additional layer of security for sensitive information and helps to ensure its confidentiality in case the electronic device 110 is lost or compromised.

The secure element 206 may include one or more interfaces for communicatively coupling (directly or indirectly) to the communication interface 208 (e.g., NFC controller) and/or the host processor 202, such as via one or more single wire protocol (SWP) connections and/or any other data connection. The secure element 206 may include a bridge applet 210 which is configured to accept a tunneled communication via one or more of the communications interfaces 208 and provide the data to a service of the secure element 206 that can forward the data to a controller in the secure element 206 which is associated with the communications protocol which is expected for the type of access credential being processed. This is explained in greater detail below. The secure element 206 can also include one or more applets 212A-N, which may be referred to herein as applets 212. The applets 212 can include, for example, Applet 212A that is programmed to provide an access credential over a first communications protocol, and which would refuse to provide the access credential over another communications protocol. In one or more implementations, the operating system and/or execution environment of the secure element 206 may be a JAVA-based operating system and/or JAVA-based execution environment, and the bridge applet 210 and applets 212 may be JAVA-based applets. In other implementations, other operating systems, languages, and/or environments can be implemented. In addition to the bridge applet 210, and the applets 212, the secure element 206 may also include one or more additional applets for performing other operations, such as a security applet, a registry applet, and the like.

The applets 212 and/or corresponding digital credentials may be provisioned on the secure element 206 at least in part by, for example, a trusted services manager (TSM) server and/or provider server 130. In some implementations, provider server 130 may be a TMS. The TSM may transmit a provisioning script to the electronic device 110 via the network 106. In some implementations, the host processor 202 of the electronic device 110 may receive the script and may provide the script to the secure element 206, such as via the communication interface 208 and/or directly to the secure element 206. The secure element 206 may perform one or more security mechanisms to verify the received script, such as one or more security mechanisms inherent in the GlobalPlatform framework and may then execute the received script.

The execution of the script by the secure element 206 may cause one or more of the applets 212 and/or corresponding digital credentials to be provisioned on the secure element 206. Each of the applets 212 may be provisioned with a one or more of an applet identifier, a digital credential, an identifier of the associated service provider, and/or one or more attributes, including, for example, a flag attribute that may allow or disallow bridge tunnelling or a channel-less interface bridge. The applet identifier associated with a given Applet 212A may be used by, for example, the host processor 202 and/or a trusted services manager server to uniquely identify the Applet 212A relative to the other applets 212B-N provisioned on the secure element 206, such as to perform one or more operations with respect to the Applet 212A. In one or more implementations, the applet identifiers may be used by the host processor 202 to store associations between the applets 212 and their corresponding service providers.

The digital credential may be associated with an account, such as a payment account, an event ticketing account, a home automation account, or an automotive control account, or the like, and further associated with a given applet, e.g., 212A of the applets 212. When conducting a request associated with the digital credential, such as a payment request, an access request, a ticket redemption request, an unlock request, and so forth, using one of the applets 212, the secure element 206 may establish a link with a terminal and provide the digital credential to a terminal over one of the communications protocols. In some instances, the terminal (e.g., electronic device 120) can verify the digital credential, such as comparing the digital credential to an access list, while in other instances, the terminal may then forward the digital credential to a service provider, e.g., provider server 130, associated with the digital credential, which can determine the account associated with the digital credential and confirm that the account contains event tickets, funds, credit, access rights, and so forth to complete a requested transaction.

In one or more implementations, each of the applets 212 may be provisioned with an attribute that indicates the type of communication protocol used by the respective applets 212 to communicate with a terminal. The types of communication protocols may include, for example, an NFC-A protocol, an NFC-B protocol, an NFC-F protocol, a UWB protocol, a Bluetooth protocol, a Bluetooth low energy (BLE) protocol, a Zigbee protocol, a Wi-Fi protocol, or generally any communication protocol.

In some implementations, one or more of the applets 212 may be associated with the same service provider, such as the same institution or credential issuing authority, and/or may be associated with different service providers. In one or more implementations, such as a host card emulation implementation, all or part of the secure element 206 may be implemented by the host processor 202, and therefore, in one or more implementations, the secure element 206 may not be included in the electronic device 110. The secure element 206 is discussed further below with respect to FIG. 3.

In one or more implementations, one or more of the host processor 202, the memory 204, the secure element 206, the communication interface 208, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

FIG. 3 depicts the secure element 206, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided. For explanatory purposes, the secure element 206 is illustrated as being implemented in the electronic device 110; however, the secure element 206 may be implemented in any other electronic device.

The secure element 206 may include, among other components, a secure processor 302, RAM 304, a security engine 306, an interface 308, and non-volatile memory 310. The RAM 304 may include one or more of static RAM (SRAM) and/or dynamic RAM (DRAM). The interface 308 may communicatively couple the secure element 206 to one or more other chips in the device, such as the communication interface 208 (e.g., NFC controller) and/or the host processor 202. The interface 308 may be, for example, a SWP interface, a USB interface, or generally any data interface. The secure processor 302 may be, for example, a reduced instruction set computing (RISC) processor, an advanced RISC machine (ARM) processor, or generally any processing circuitry.

The security engine 306 may perform one or more security operations for the secure element 206. For example, the security engine 306 may perform cryptographic operations and/or may manage cryptographic keys and/or certificates. In one or more implementations, the communications between the secure element 206 and an external device, such as a wireless payment terminal and/or trusted services manager server may be encrypted. For example, for NFC-F communications, an encryption key may be dynamically generated each time mutual authentication is performed. In these one or more implementations, the encryption/decryption and/or key generation/management may be performed all or in part by the security engine 306.

The non-volatile memory 310 may be and/or may include, for example, flash memory. The non-volatile memory 310 may store the attributes and executable code associated with an application layer 312 of the secure element 206, including the bridge applet 210 and applets 212, e.g., one or more of Applets 212A-N. In one or more implementations, the non-volatile memory 310 may also store a system layer 313 including firmware and/or operating system executable code that is executed by the secure processor 302 to provide the execution environment for the bridge applet 210 and applets 212, such as a JAVA execution environment. The system layer 313 can include interface controller elements for processing data received over certain communication protocols. For example, the system layer 313 can include a COM 1 communications interface controller 316, a COM 2 communications interface controller 318, and so forth up to a COM N communications interface controller 320, for example, where COM 1, COM 2, and up to COM N each correspond to a different communications protocol. In some implementations, for example, the controllers may correspond to one or more of a wired communication handler (e.g., such as used in a near-field communication (NFC) controller interface (NCI), which may utilize various physical transports such as universal asynchronous receiver / transmitter (UART)), one or more Inter-Integrated Circuit (I2C) communication protocol transports (e.g., I2C_A (which could be used for Bluetooth) and I2C_B (which could be used for UWB communications)), and a host controller interface (HCI) communication protocol (e.g., which may be used for NFC communications (see above for descriptions of different types)). These represent one particular implementation, and it should be understood that communication protocols can flexibly be implemented. Implementations further contemplate the support of additional communications protocols, as implementations are not dependent on which types of communications protocols are used. For example, a line-of-sight infrared protocol could be implemented or an auditory protocol, such as an ultrasonic protocol, could be implemented utilizing the subject technology discussed herein. The use of a particular communication protocol depends on the communication interface used to perform the exchange of the digital credential. The system layer may also include hardware abstraction layer (HAL) 322, which can be a logic element for providing an interface to reduce complexities of interacting with the secure element 206. The non-volatile memory 310 may also include attributes and executable code associated with an implementation of application programming interfaces (APIs) 314 of the secure element 206. These can include, for example, a bridge service 324 which can be used in the implementations of the subject technology for providing functionality related to tunnelling data as described herein below. The APIs can also include a command dispatcher 326 which can correspond to a standards (e.g., GlobalPlatform) compliant coordinator for processing requests to the secure element and forwarding, for example, data from an interface via a particular communications protocol to an applet 212 associated with that interface and communications protocol. In general, the command dispatcher 326 may be omitted from the discussion of the various implementations, however, it should be understood that use of the command dispatcher 326 may be included in each of the flows below in the manner noted here.

The bridge applet 210 may be responsible for orchestrating the tunneling logic at the application layer within the secure element. The bridge applet 210 can be a standalone applet or have its functionality integrated into an existing applet. It may use the bridge service 324 to manage tunneling sessions and exchange data to and from channel-less (i.e., virtual) interfaces. The bridge applet 210 is also responsible to manage all of the active bridge sessions (including tunnelling and channel-less sessions) and ensure the session binding to the targeted interface, e.g., the native interface of the targeted digital credential. In a scenario when a physical interface takes over an open tunnelling or channel-less session, such as further described below, the bridge applet 210 is responsible to clean up the sessions and processes such that the system can recover gracefully prior to the next usage. Bridge service 324 enables an application to tunnel data over a bridge interface while inheriting the same properties of the physical interfaces. Multiple applications can use bridge service 324, however in some implementations, only one application can have an active bridged session for a given tunnelling or channel-less interface at a time. The bridge service 324 enables initializing and de-initializing protocols for each tunnelling and/or channel-less interface. Some interfaces can be protocol or technology specific and in such aspects, the bridge service 324 also provides APIs to fully emulate all interfaces properties as if it were the physical interface. For example, for an NFC type F, a CTL command is needed to initiate the protocol. The bridge service 324 can ensure such aspects are emulated for the appropriate protocols.

In one or more implementations, one or more of the secure processor 302, the RAM 304, the security engine 306, the interface 308, the non-volatile memory 310, and/or one or more portions thereof, may be implemented in software (e.g., subroutines and code), hardware (e.g., an ASIC, an FPGA, a PLD, a controller, a state machine, gated logic, discrete hardware components, or any other suitable devices) and/or a combination of both.

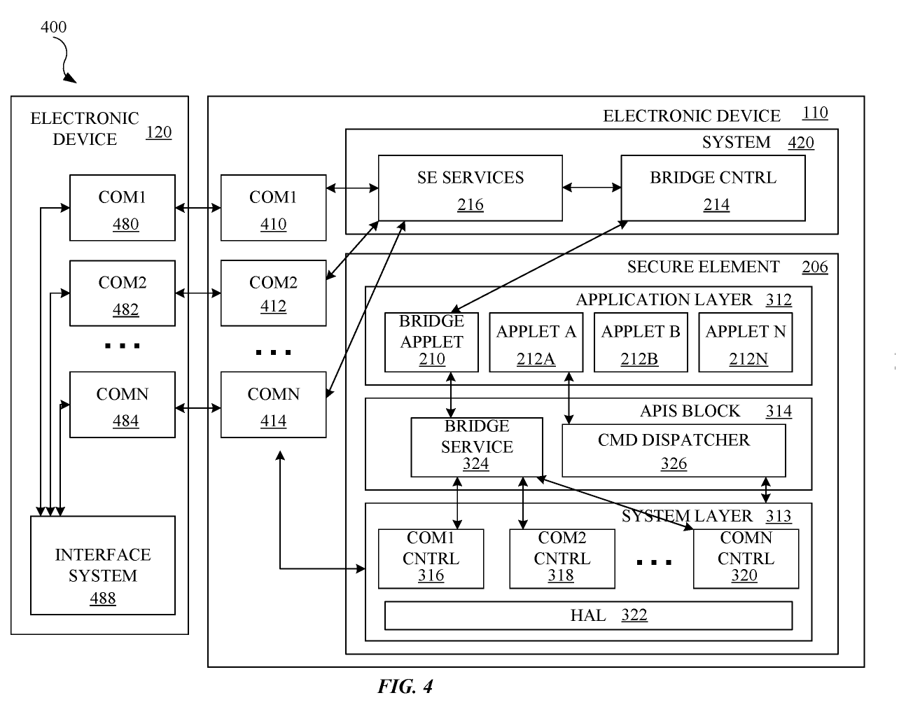

FIG. 4 depicts a system diagram 400 including the electronic device 110 and electronic device 120 to illustrate aspects of a data flow between elements of the electronic device 110 and electronic device 120 when a communication session is established between the electronic device 110 and the electronic device 120, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided. While some arrows are provided to aid in the discussion, below, it should be noted and understood that the absence of an arrow does not imply that no communication occurs between elements.

The electronic device 110 is depicted, such as the electronic device described above with respect to FIG. 3. The electronic device 110 includes physical communication interfaces, such as a first communication interface 410, a second communication interface 412, and an Nth communication interface 414. The communication interfaces may include any of the radios or communication interfaces discussed above. The electronic device includes system components 420, which may correspond to functional programs of the operating system of the electronic device 110. Components include a secure element services module 216 and a bridge controller 214.

The secure element 206 is depicted as being part of the electronic device 110. The secure element includes the components previously discussed with respect to FIG. 3.

The electronic device 120 is depicted. The electronic device 120 includes physical communication interfaces, such as a first communication interface 480, a second communication interface 482, and so on, up to an Nth communication interface 484. The electronic device 120 includes an interface system 488, which may correspond to a terminal application, in some implementations. The interface system 488 may further communicate with the provider server 130. In some implementations the interface system 488 may include some or all of the components of the electronic device 110, such as the system components 420, secure element 206, and APIs 314. One example of the interface system 488 may be a terminal application for authenticating a user for unlocking a door based on access credentials presented via the electronic device 110 over a communications interface. Another example of the interface system 488 may be a terminal application for authenticating a user in a building based on access credentials that can be presented to different electronic devices, such as the electronic device 120 as the user travels within a specified area of the building. For example, a secure facility may authorize and track a user’s presence via access credentials presented over a UWB communication interface. Another example of the interface system 488 may correspond to a payment processing device, such as a point-of-sale device, which can process a transaction of a presented access credential corresponding to a payment method.

Each of the first communication interface 410, second communication interface 412, and Nth communication interface 414 can respectively communicate to a corresponding first communication interface 480, second communication interface 482, and Nth communication interface 484. When a connection is established between a communication interface from the electronic device 110 and a corresponding communication interface from the electronic device 120, data can be exchanged over the connection, e.g., transmitted or received between the two devices. Although the arrows imply a direct connection (e.g., a private network or peer-to-peer connection), which is contemplated, it should be understood that, in some implementations, a router device could be used to route data between the respective interfaces of the electronic device 110 and the electronic device 120.

When a communication occurs from the electronic device 120 to the electronic device 110 over a communication interface, the information received can be provided to the secure element services module 216 of the system components 420. Similarly, when a communication occurs from the electronic device 110 to the electronic device 120, the secure element services module 216 can interface with the physical communication devices of the electronic device 110. The secure element services module 216 may correspond, for example, to system drivers and the like to provide the ability to interface with the physical communication devices, such as the first communications interface 410 and second communications interface 412, and so forth. The secure element services module 216 can forward the data received to the bridge controller 214. The bridge controller 214 can then determine that the data should be provided to the bridge applet 210 and forward the data to the bridge applet 210 of the secure element 206. The bridge applet 210 can determine which interface the data pertains to and interact with the bridge service 324 to establish a tunnel to an interface controller corresponding to the targeted interface. For example, if the data pertains to a contactless interface, the bridge applet 210 can determine to send the data to the communications interface for the HCI controller, however, another controller may be used in accordance with the system design.

The bridge applet 210 can then forward the data. In one implementation, the data can be forwarded by a tunnel to the communication interface controller for the appropriate interface (i.e., the interface which was targeted) over the tunnel. The tunnel essentially packages the data to provide an emulation of the data to the communication interface controller as if it were received over the communication interface which corresponds to the communication interface controller. In another implementation, the data can be forwarded to the command dispatcher 326 without tunnelling the communication, but with specifying a targeted interface or targeting applet.

In implementations which use tunnelling, the communications interface which receives the tunneled data can forward the data to the command dispatcher 326. The command dispatcher 326 can then forward the data to the appropriate application (e.g., Applet 212A, Applet 212B, or Applet 212N, etc.) for processing.

The security protocols, such as Javacard rules, programmed into the various applications and command dispatcher 326 can be satisfied because, from the perspective of the command dispatcher 326 and the target applet (e.g., Applet 212A, Applet 212B, or Applet 212N, etc.), the command is coming from the bridge service 324 in the secure element 206. The bridge service 324 essentially looks like a virtual reader from the perspective of the command dispatcher 326 or target applet, and because it is hosted in the secure element, the security features can be satisfied.

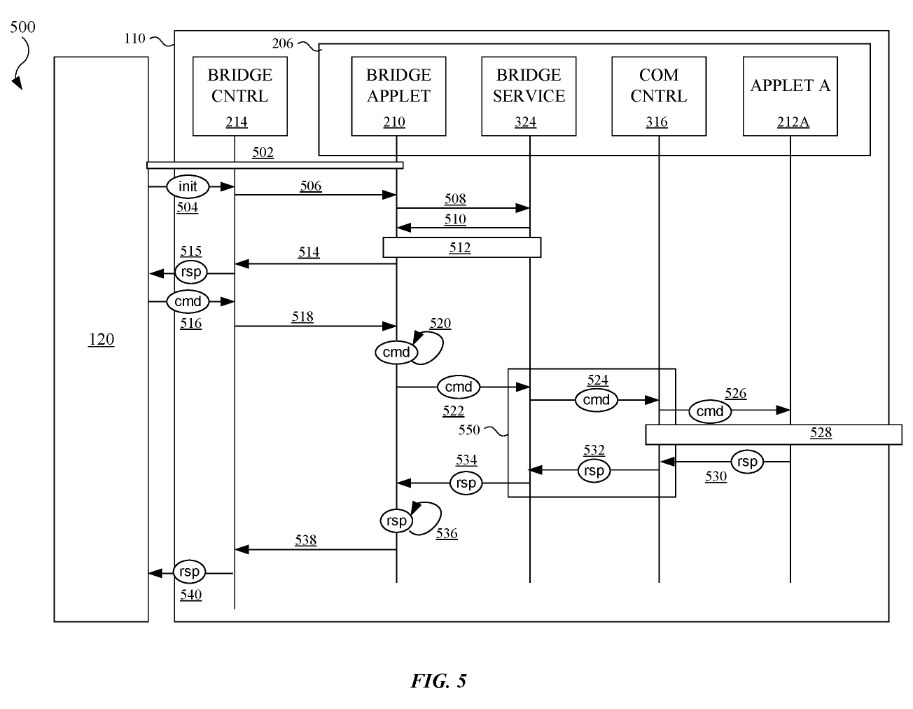

Data provided by the applet back to the electronic device 120 can be provided in reverse order. The Applet 212A, for example, can provide data to the command dispatcher 326, which can then provide it back to the communication interface controller, which can provide it back through the tunnel to the bridge service 324. The bridge service 324 can provide it back to the bridge applet 210 which can send it to the bridge controller 214, then to the communications interface and to the electronic device 120. The process associated with the system depicted in FIG. 4 may be further understood from the sequence diagram depicted in FIG. 5.

FIG. 5 depicts a sequence diagram of a process 500 for a validation session to provide an access credential, in accordance with one or more implementations. For explanatory purposes, the process 500 is primarily described herein with reference to the electronic device 110 and the electronic device 120 of FIGS. 1-4. However, the process 500 is not limited to the electronic device 110 and the electronic device 120. Further, for explanatory purposes, the periods of the process 500 are described herein as occurring sequentially or linearly. However, multiple periods of the process 500 may occur in parallel. In addition, the periods of the process 500 need not be performed in the order shown and/or one or more periods of the process 500 need not be performed and/or can be replaced by other operations.

At period 502, to start the digital credential presentation process, a user may launch a digital wallet application on their electronic device 110. The digital wallet may be a software application designed to manage access credentials, such as access cards, payment cards, electronic tickets, electronic keys (automotive keys or house keys), and so forth, and may serve as the interface through which the user interacts with a broader access and payment ecosystem. Upon launching the digital wallet application, the user may be presented with various options, including selecting an access credential to use in a validation session to provide a digital access credential to a reading device, such as the electronic device 120. Upon selection, the electronic device 110 may seek a suitable communication partner (e.g., the electronic device 120) through which to provide the access credential. In some implementations, the digital wallet may wait until the selection at the electronic device 110. In other implementations, the digital wallet may be able to poll for devices such as the electronic device 120, for example, in a background process that periodically seeks to use stored access credentials. In yet other implementations, the electronic device 120 may send a signal to the electronic device 110 that causes a background process on the electronic device 110 to present an access credential to the electronic device 120. In implementations, the access credential may be associated with one type of communication technology and the communication technology used between the electronic device 110 and the electronic device 120 may be a different communication technology. For the sake of simplicity, the discussion below will discuss a communication session over a UWB radio and an expected communication session over NFC, however, it should be understood that these are merely examples and any two communications technologies may be substituted.

For example, the electronic device 110 may come in ranging proximity to the UWB radio of the electronic device 120 and a secure channel may be established between electronic device 120 and the bridge applet 210 in response to a request from the electronic device to the bridge controller 214 to activate a session.

At period 504, an initialization command may be sent from the electronic device 120 over the secure channel to the bridge controller 214 to initialize a tunnel for the other communication interface, in this example, the NFC communication interface. For example, the electronic device 120 may be programmed to provide an indication that it wants to request access credentials over a different interface than the secure channel. In another implementation, the bridge controller 214 may be programmed to understand that a UWB communication with the electronic device 120 should be processed using a different protocol. In such implementations, the initialization command may be an initialization command for the UWB communication interface which is then received at the bridge controller 214 where the bridge controller 214 determines that it should be processed into a tunnel request for an applet in the secure element configured to accept a different communication interface.

At period 506, the bridge controller 214 may provide an initialization command to the bridge applet 210 to open a tunnel between the bridge applet 210 and the bridge service 324. At period 508, the bridge applet 210 can access the bridge service 324 to send an open tunnel command. The tunnel establishes that, as each element sends or receives data, it will be wrapped with information to indicate that the other communication protocol was used, in this example, an NFC protocol, thereby emulating an NFC data element rather than a UWB communication element. At period 510, the bridge applet 210 can receive a response from the bridge service 324 that the tunnel was successfully initialized.

At period 512, the bridge applet 210 and bridge service 324 can continue to communicate to configure optional aspects of the tunnel. For example, a command can be sent from the bridge applet 210 to set a timeout parameter on the tunnel. As another example, a command can be sent from the bridge applet to specify certain header values for wrapping / emulating the communication protocol.

At period 514, the bridge applet 210 can send a message to the bridge controller 214 that the tunnel was successfully created and is ready for transmission. At period 515, a response can be sent to the electronic device 120 that the electronic device 110 is ready to receive.

At period 516, the electronic device 120 sends a command via the secure channel to the bridge controller 214. The command may correspond, for example, to a request for an access credential, a request to add, modify, or delete an access credential, a request for personal information associated with an access credential, and so forth; the command may further be associated with a particular Applet of the secure element. The command is sent, in this example, using the UWB communication interface. The command may contain, for example, encrypted APDUs designated for the Applet 212A and for requesting a digital access credential associated with the Applet 212A. The bridge controller 214 may receive the command. At period 518, rather than forward the command to the communication controller for the UWB communication interface, e.g., an I2C interface, such as the communications interface controller 318, the bridge controller forwards it to the bridge applet 210. Because the bridge applet 210 can be enabled to receive data from any of the communication channels, the bridge applet 210 can receive the command from the bridge controller 214.

At period 520, the bridge applet 210 can unwrap the command from the UWB message, for example, by stripping any communication header information related to the UWB protocol or use of the UWB interface. The command itself may remain encrypted or, in some implementations, the command may be decrypted. Further, the command may include an encrypted command with an encrypted payload and that the encrypted payload can remain encrypted while the encrypted command is decrypted. The command may include a request, for example, for the digital access credential corresponding to Applet 212A which is provided via the communication interface controller 316, such as an HCI controller. In some implementations, the bridge applet 210 can analyze the command and the request included with the command corresponding to a particular controller, particular Applet, or particular digital access credential, any one of which may be used to determine the other two. A particular Applet may correspond to a particular communication interface and a particular digital access credential. A particular communication interface may correspond to a particular Applet and a particular digital access credential. A particular digital access credential may correspond to a particular communication interface and a particular Applet.

At period 522, the bridge applet 210 can forward the command (and payload) to the bridge service 324. Because the tunnel 550 was previously set up and associated with the secure session (e.g., at period 502) between the electronic device 110 and the electronic device 120, the bridge service 324 tunnels the command at period 524 to a communication interface controller 316, such as an HCI controller, which is associated with Applet 212A and the requested digital access credential. The bridge service 324, for example, can wrap the command with a communications wrapper that corresponds to the communication interface associated with the communication interface controller 316, in this example, an HCI communication protocol typically provided over an NFC communication interface. This effectively emulates the communication protocol associated with the communication interface controller 316.

At period 526, the communication interface controller 316 can forward the command to the associated applet, in this case, Applet 212A. Applet 212A can then process the command as if it were received via the communication interface (e.g., NFC) associated with the communication interface controller 316 (e.g., HCI). In some implementations, wrapping the command by the bridge service 324 to utilize the tunnel 550 may include providing an indication that the command is wrapped or emulated. The Applet 212A can use this indication to determine how to handle the command. For example, the Applet 212A can have a configuration associated therewith, which may be established when the Applet is provisioned, where the configuration allows or disallows tunnelling to the Applet in question, in this case, Applet 212A. Further, if the Applet allows tunnelling, the Applet may limit the functionality provided by the Applet. For example, if the command is a command to update, replace, or delete an access credential associated with the Applet, the Applet may be configured to disallow such commands over a tunneled connection and may instead require a connection over the native interface for the Applet.

Skipping for a moment to period 530, based on the command and, in some aspects, the security settings associated with receiving the command over a tunneled connection, the Applet 212A can determine a suitable response satisfying the command or an error message if the command cannot be executed. In some implementations, the applet can also decrypt the command to be able to read the command in order to determine a response. In some implementations, the Applet 212A can encrypt the response prior to sending the response. The Applet 212A can send the response back to the communication interface controller 316. At period 532, the communication interface controller 316 can prepare the response to communicate via the communication interface, e.g., an HCI interface, and send the response via the tunnel 550 to the bridge service 324. For example, the communication interface controller 316 can wrap the response within a data packet corresponding to the communication interface. Once received, the bridge service 324 can strip off the data packaging provided by the communication interface controller 316.

At period 534, the bridge service 324 can provide the response to the bridge applet 210. At period 536, the bridge applet 210 can wrap the response based on the communication protocol for the secure session between the electronic device 110 and the electronic device 120. In the present example, for instance, the response can be wrapped as a payload for a UWB data packet. If the secure session access were over the native communication interface, for example, the response would have been wrapped by the communication interface controller 316 and provided to the communication interface. Since tunnelling the response strips the wrapper from the communication interface controller 316 off, the bridge applet 210 can replace the wrapper with a wrapper corresponding to the secure session interface, e.g., the UWB interface in this instance.

At period 538, the bridge applet 210 can provide the response to the bridge controller 214. At period 540, the bridge controller 214 can return the response over the secure channel to the electronic device 220. Following the secure session, the bridge controller 214 can manage closing the tunnel without further input from the electronic device 120.

In the case where, for example, a user device is using UWB to establish location of the device in an area, for example, for unlocking a car door, remotely starting a car, or unlocking a house door, the secure element can be used as if a tap (NFC) operation were being processed rather than a UWB, thereby advantageously utilizing existing programming for a different communication interface. This is, of course, merely an example, and other specific uses and protocols may be used utilizing the subject technology.

Returning to period 528, period 528 illustrates a situation where at some point in the process from period 502 to period 540 a user may initiate a communication session over the native interface corresponding to the communication interface controller 316 (and the corresponding applet 212, such as the Applet 212A in this example). For instance, where the native communication protocol corresponds to an NFC, during the tunnelling process, the NFC radio may be instantiated. The native interface is generally considered to be preferred. As such, it may be desired that the tunnelling communication is aborted in favor of the native transaction. In the example case described here, the tunnelling interface is over UWB and the native interface is NFC. If the NFC interface is activated, i.e., tapped, during the process of tunnelling, the tunnelling can be immediately aborted, and a new secure session can be established through the native interface. In such an instance, the bridge applet 210 and/or the bridge controller 214 can send commands to clean up the artifacts of the secure session gracefully. For example, the bridge applet 210 can send a command to the bridge service 324 to release the tunnel and close out the processes associated with the bridge applet 210 and bridge controller 214.

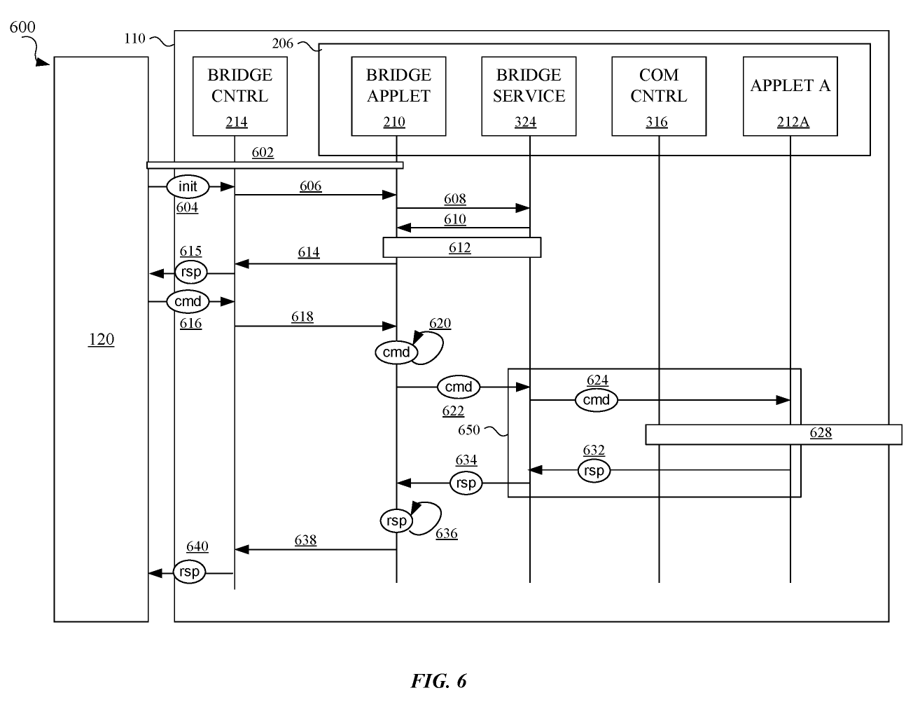

FIG. 6 depicts a sequence diagram of a process 600 for a validation session to provide an access credential, in accordance with one or more implementations. For explanatory purposes, the process 600 is primarily described herein with reference to the electronic device 110 and the electronic device 120 of FIGS. 1-4. However, the process 600 is not limited to the electronic device 110 and the electronic device 120. Further, for explanatory purposes, the periods of the process 600 are described herein as occurring sequentially or linearly. However, multiple periods of the process 600 may occur in parallel. In addition, the periods of the process 600 need not be performed in the order shown and/or one or more periods of the process 600 need not be performed and/or can be replaced by other operations.

At period 602, to start the digital credential presentation process, a user may launch a digital wallet application on their electronic device 110. These aspects are similar to that described above with respect to period 502 and are not repeated, however, rather than process the data over a tunnel to emulate the communication interface controller, the data is processed over a channel-less (i.e., virtual) interface, as described in greater detail herein. In such aspects, the bridge applet 210 can act as a virtual reader and the Applet 212A can be provisioned with the ability to accept data either from its native hardware interface or from a channel-less interface provided by the bridge applet 210. In some instances, the Applet 212A can, for example, allow some, but not all operations over the channel-less interface as compared to those allowed over the native interface.

At period 604, an initialization command may be sent from the electronic device 120 over the secure channel to the bridge controller 214 to initialize a channel-less interface to handle the data instead of the native communication interface, in this example, the NFC communication interface. For example, the electronic device 120 may be programmed to provide an indication that it wants to request access credentials over a channel-less interface since it is not the native interface for the operation. In another implementation, the bridge controller 214 may be programmed to understand that a UWB communication with the electronic device 120 should be processed using a different protocol and if the applet 212 is able to use the channel-less interface, provide a channel-less interface, otherwise provide a tunnel interface. In such implementations, the initialization command may be an initialization command for the UWB communication interface which is then received at the bridge controller 214 where the bridge controller 214 determines that it should be processed into a channel-less request (or a tunnel request, as discussed above) for an applet in the secure element configured to accept a different communication interface, natively.

At period 606, the bridge controller 214 may provide an initialization command to the bridge applet 210 to begin a channel-less interface for use in conjunction with the bridge applet 210 and the bridge service 324. At period 608, the bridge applet 210 can access the bridge service 324 to send an open channel-less interface command. The channel-less interface establishes that, as each element sends or receives data, it can be formatted in a manner that indicates it is from a channel-less or virtual interface rather than a hardware interface. At period 610, the bridge applet 210 can receive a response from the bridge service 324 that the channel-less interface was successfully initialized.

At period 612, the bridge applet 210 and bridge service 324 can continue to communicate to configure optional aspects of the channel-less interface. For example, a command can be sent from the bridge applet 210 to set a timeout parameter on the channel-less interface. As another example, a command can be sent from the bridge applet to specify certain header values for wrapping the data for the Applet 212A or providing a data element expected for the native communication protocol, for example, an NFC communication may include a particular header value which is desired, and such a value can be provided through configuring optional aspects of the channel-less interface.

At period 614, the bridge applet 210 can send a message to the bridge controller 214 that the channel-less interface was successfully created and is ready for transmission. At period 615, a response can be sent to the electronic device 120 that the electronic device 110 is ready to receive.

At period 616, the electronic device 120 sends a command via the secure channel to the bridge controller 214. The command may correspond, for example, to a request for an access credential, a request to add, modify, or delete an access credential, a request for personal information associated with an access credential, and so forth; the command may further be associated with a particular Applet of the secure element. The command is sent, in this example, using the UWB communication interface. The command may contain, for example, encrypted APDUs designated for the Applet 212A and for requesting a digital access credential associated with the Applet 212A. The bridge controller 214 may receive the command. At period 618, rather than forward the command to the communication controller for the UWB communication interface, e.g., an I2C interface, such as the communications interface controller 318, the bridge controller forwards it to the bridge applet 210. Because the bridge applet 210 can be enabled to receive data from any of the communication channels, the bridge applet 210 can receive the command from the bridge controller 214.

At period 620, the bridge applet 210 can unwrap the command from the UWB message, for example, by stripping any communication header information related to the UWB protocol or use of the UWB interface. This aspect may be performed using processes similar to those discussed above with respect to period 520, which are not repeated.

At period 622, the bridge applet 210 can forward the command (and payload) to the bridge service 324. Because the channel-less interface 650 was previously set up and associated with the secure session (e.g., at period 602) between the electronic device 110 and the electronic device 120, the bridge service 324 provides the command at period 624 to the Applet 212A. The bridge service 324, for example, can provide the command over the channel-less interface 650. Applet 212A can then process the command. Providing the command by the channel-less interface 650 includes an indication that the command is sent via the channel-less interface instead of the native interface. The Applet 212A can use this indication to determine how to handle the command. For example, the Applet 212A can have a configuration associated therewith, which may be established when the Applet is provisioned, where the configuration allows or disallows a command sent via a channel-less interface to the Applet in question, in this case, Applet 212A. Further, if the Applet allows a channel-less interface, the Applet may limit the functionality provided by the Applet. For example, if the command is a command to add, update, replace, or delete an access credential associated with the Applet, the Applet may be configured to disallow such commands over a channel-less interface and may instead require a connection over the native interface for the Applet.

Skipping for a moment to period 632, based on the command and, in some aspects, the security settings associated with receiving the command over a tunneled connection, the Applet 212A can determine a suitable response satisfying the command or an error message if the command cannot be executed. In some implementations, the applet can also decrypt the command to be able to read the command in order to determine a response. In some implementations, the Applet 212A can encrypt the response prior to sending the response. The Applet 212A can send the response back to the bridge service via the channel-less interface.

At period 634, the bridge service 324 can provide the response to the bridge applet 210. At period 636, the bridge applet 210 can wrap the response based on the communication protocol for the secure session between the electronic device 110 and the electronic device 120. In the present example, for instance, the response can be wrapped as a payload for a UWB data packet. If the secure session access were over the native communication interface, for example, the response would have been wrapped by the communication interface controller 316 and provided to the communication interface. Since the channel-less interface can use its own protocol, the bridge applet 210 can add a wrapper corresponding to the secure session interface, e.g., the UWB interface in this instance.

At period 638, the bridge applet 210 can provide the response to the bridge controller 214. At period 640, the bridge controller 214 can return the response over the secure channel to the electronic device 220. Following the secure session, the bridge controller 214 can manage closing the tunnel without further input from the electronic device 120.

In the case where, for example, a user device is using UWB to establish location of the device in an area, for example, for unlocking a car door, remotely starting a car, or unlocking a house door, the secure element can be used as if a tap (NFC) operation were being processed rather than a UWB, thereby advantageously utilizing existing programming for a different communication interface. This is, of course, merely an example, and other specific uses and protocols may be used utilizing the subject technology.

Returning to period 628, period 628 illustrates a situation where at some point in the process from period 602 to period 640 a user may initiate a communication session over the native interface corresponding to the communication interface controller 316 (and the corresponding applet 212, such as the Applet 212A in this example). For instance, where the native communication protocol corresponds to an NFC, during the channel-less communication process, the NFC radio may be instantiated. The native interface is generally considered to be preferred. As such, it may be desired that the channel-less communication is aborted in favor of the native communication. In the example case described here, the native interface is NFC. If the NFC interface is activated, i.e., tapped, during the process of channel-less communication, the channel-less communication can be immediately aborted, and a new secure session can be established through the native interface. In such an instance, the bridge applet 210 and/or the bridge controller 214 can send commands to clean up the artifacts of the secure session gracefully. For example, the bridge applet 210 can send a command to the bridge service 324 to release the channel-less interface and close out the processes associated with the bridge applet 210 and bridge controller 214.

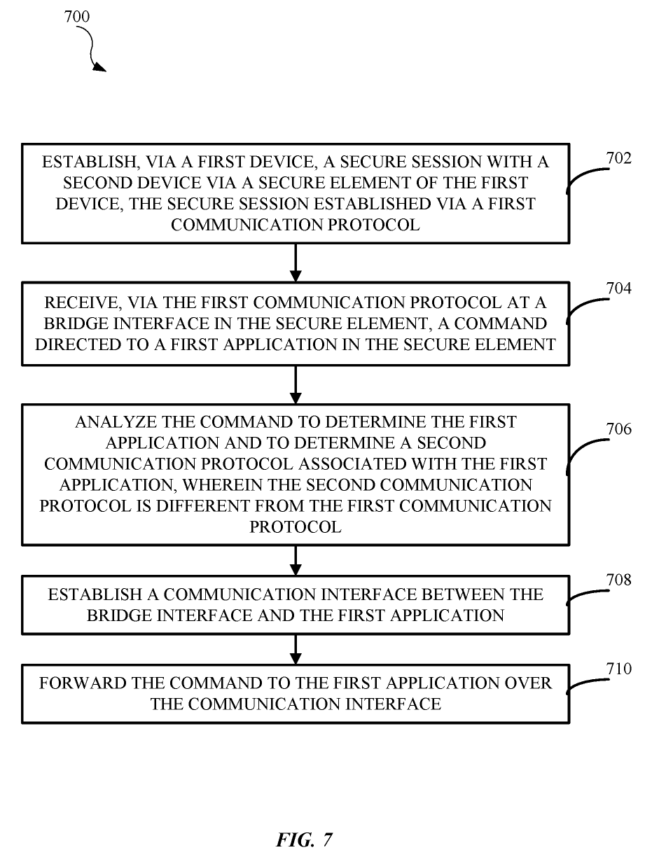

FIG. 7 depicts a flow diagram of an example process 700 for utilizing a non-native communication protocol, e.g., tunnelling or a channel-less interface, to communicate with an applet in a secure element of a device which expects communication over a native communication protocol, for the purpose of obtaining a stored digital access credential associated with the applet. For explanatory purposes, the process 700 is primarily described herein with reference to the electronic device 110, the electronic device 120, and the provider server 130 of FIGS. 1-4. However, the process 700 is not limited to the electronic device 110, the electronic device 120, or the provider server 130. Further, for explanatory purposes, the blocks of the process 700 are described herein as occurring sequentially or linearly. However, multiple blocks of the process 700 may occur in parallel. In addition, the blocks of the process 700 need not be performed in the order shown and/or one or more blocks of the process 700 need not be performed and/or can be replaced by other operations.

As shown in FIG. 7, at block 702, process 700 may include establishing, via a first device, a secure session with a second device via a secure element of the first device, the secure session established via a first communication protocol. As noted above, for example with respect to FIG. 5, the first device and the second device may establish a secure session with one another over a first communication protocol. In some implementations, the first communication protocol, for example, can correspond to a contactless-type A, contactless-type B, contactless-type F, I2C_A, or I2C_B protocol. In some implementations, the first communication protocol, for example, can correspond to one of Bluetooth, ultra-wideband (UWB), Wi-Fi, or NFC. This process block can correspond to period 502 or period 602, described above.

As also shown in FIG. 7, at block 704, process 700 may include receiving, via the first communication protocol at a bridge interface in the secure element, a command directed to a first application in the secure element. For example, the bridge applet 210 in the secure element 206 can correspond to the bridge interface, the bridge interface providing an ability to bridge the first communication protocol to another communication protocol. Block 704 can correspond to period 518 and/or 618 of FIGS. 5 and 6, respectively.

As further shown in FIG. 7, at block 706, process 700 may include analyzing the command to determine the first application and to determine a second communication protocol associated with the first application, where the second communication protocol is different from the first communication protocol. Block 704 can correspond to period 520 and/or 620 of FIGS. 5 and 6, respectively.

As also shown in FIG. 7, at block 708, process 700 may include establishing a communication interface between the bridge interface and the first application. For example, the communication interface may correspond to a tunnel interface or a channel-less interface. Block 708 can correspond to periods 504-515 and/or periods 604-615 of FIGS. 5 and 6, respectively.

As further shown in FIG. 7, at block 710, process 700 may include forwarding the command to the first application over the communication interface. Block 710 can correspond to periods 524 and 526 and/or period 624 of FIGS. 5 and 6, respectively.

In accordance with some implementations, establishing the communication interface may further include establishing a tunnel between the bridge interface and the first application, where the tunnel is configured to wrap the command based on the second communication protocol, where forwarding the command to the first application over the communication interface includes forwarding the command over the tunnel. Process 700 may include verifying that a configuration flag for the first application indicates that the first application allows tunnelling. As noted above if the application does not allow tunnelling or restricts tunnelling, the application can fail to execute commands in some instances.

In accordance with some implementations, establishing the tunnel comprises: requesting, at a service running within a standards-compliant logic block, to provide an interface address for a controller program running in the secure element that corresponds to the second communication protocol; and establishing the tunnel based on the interface address, where the command is wrapped in a payload corresponding to the second communication protocol. The interface address can correspond, for example, to a mechanism of sending information via the interface, e.g., through an interface address for the controller program. In some implementations, the second communication protocol can be a different protocol that the first communications protocol and can, for example, correspond to a contactless-type A, contactless-type B, contactless-type F, I2C_A, or I2C_B protocol and/or can correspond to an interface including one of Bluetooth, ultra-wideband (UWB), Wi-Fi, or NFC and so forth.

In implementations, the first application may respond, for example, by providing a digital access credential over the communication interface, and forwarding the response to the second device over the first communication protocol.

In accordance with some implementations, establishing the communication interface may include establishing a channel-less interface between the bridge interface and the first application, where forwarding the command to the first application over the communication interface includes forwarding the command via the channel-less interface. Process 700 may include verifying that a configuration flag for the first application indicates that the first application allows communication from a channel-less interface. As noted above, if the application does not allow a channel-less interface or restricts channel-less interfaces, the application can fail to execute commands in some instances.

In one example instance of the process 700, the command may correspond to a ranging operation to determine a range between the first device and the second device.

FIG. 8 depicts an example electronic system 800 with which aspects of the present disclosure may be implemented, in accordance with one or more implementations. The electronic system 800 can be, and/or can be a part of, any electronic device for generating the features and processes described in reference to FIGS. 1-7, including but not limited to a laptop computer, tablet computer, smartphone, and wearable device (e.g., smartwatch, fitness band). The electronic system 800 may include various types of computer-readable media and interfaces for various other types of computer-readable media. The electronic system 800 includes one or more processing unit(s) 814, a persistent storage device 802, a system memory 804 (and/or buffer), an input device interface 806, an output device interface 808, a bus 810, a ROM 812, one or more processing unit(s) 814, one or more network interface(s) 816, a secure element 818, and/or subsets and variations thereof.

The bus 810 collectively represents all system, peripheral, and chipset buses that communicatively connect the numerous internal devices of the electronic system 800. In one or more implementations, the bus 810 communicatively connects the one or more processing unit(s) 814 with the ROM 812, the system memory 804, and the persistent storage device 802. From these various memory units, the one or more processing unit(s) 814 retrieves instructions to execute and data to process in order to execute the processes of the subject disclosure. The one or more processing unit(s) 814 can be a single processor or a multi-core processor in different implementations.

The ROM 812 stores static data and instructions that are needed by the one or more processing unit(s) 814 and other modules of the electronic system 800. The persistent storage device 802, on the other hand, may be a read-and-write memory device. The persistent storage device 802 may be a non-volatile memory unit that stores instructions and data even when the electronic system 800 is off. In one or more implementations, a mass-storage device (such as a magnetic or optical disk and its corresponding disk drive) may be used as the persistent storage device 802.

In one or more implementations, a removable storage device (such as a floppy disk, flash drive, and its corresponding disk drive) may be used as the persistent storage device 802. Like the persistent storage device 802, the system memory 804 may be a read-and-write memory device. However, unlike the persistent storage device 802, the system memory 804 may be a volatile read-and-write memory, such as RAM. The system memory 804 may store any of the instructions and data that one or more processing unit(s) 814 may need at runtime. In one or more implementations, the processes of the subject disclosure are stored in the system memory 804, the persistent storage device 802, and/or the ROM 812. From these various memory units, the one or more processing unit(s) 814 retrieves instructions to execute and data to process in order to execute the processes of one or more implementations.

The bus 810 also connects to the input device interfaces 806 and output device interfaces 808. The input device interface 806 enables a user to communicate information and select commands to the electronic system 800. Input devices that may be used with the input device interface 806 may include, for example, alphanumeric keyboards, touch screens, and pointing devices. The output device interface 808 may enable the electronic system 800 to communicate information to users. For example, the output device interface 808 may provide the display of images generated by electronic system 800. Output devices that may be used with the output device interface 808 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 810 also connects to secure element 818. The secure element 818 may include hardware and/or software that provides secure storage and management of sensitive information. The secure element 818 may be isolated from the processing unit 814 and operating system, making it more difficult for unauthorized access. The secure element 818 may be used for secure transactions and identification, such as in payment cards and digital passes. The secure element 818 may store sensitive information, such as cryptographic keys, and may protect the sensitive information (e.g., with cryptographic algorithms and access controls).

Finally, as shown in FIG. 8, the bus 810 also couples the electronic system 800 to one or more networks and/or to one or more network nodes through the one or more network interface(s) 816. In this manner, the electronic system 800 can be a part of a network of computers (such as a local area network, a wide area network, an Intranet, or a network of networks, such as the Internet). Any or all components of the electronic system 800 can be used in conjunction with the subject disclosure.

Implementations within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

As described above, one aspect of the present technology is the gathering and use of data available from specific and legitimate sources for file sharing. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user’s health or level of fitness (e.g., vital signs measurements, medication information, exercise information), date of birth, or any other personal information.

The present disclosure recognizes that the use of such personal information data, in the present technology, can be used to the benefit of users. For example, personal information data can be used for file sharing. Accordingly, the use of such personal information data may facilitate transactions (e.g., online transactions). Further, other uses for personal information data that benefit the user are also contemplated by the present disclosure. For instance, health and fitness data may be used, in accordance with the user’s preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of file sharing, the present technology can be configured to allow users to select to “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user’s privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
establishing, via a first device, a secure session with a second device via a secure element of the first device, the secure session established via a first communication protocol;
receiving, via the first communication protocol at a bridge interface in the secure element, a command directed to a first application in the secure element;
analyzing the command to determine the first application and to determine a second communication protocol associated with the first application, wherein the second communication protocol is different from the first communication protocol;
establishing a communication interface between the bridge interface and the first application; and
forwarding the command to the first application over the communication interface.

2. The method of claim 1, further comprising:
receiving a response from the first application at the bridge interface over the communication interface; and
forwarding the response to the second device over the first communication protocol.

3. The method of claim 1, wherein establishing the communication interface includes:
establishing a tunnel between the bridge interface and the first application, wherein the tunnel is configured to wrap the command based on the second communication protocol, wherein forwarding the command to the first application over the communication interface includes forwarding the command over the tunnel.

4. The method of claim 3, further comprising verifying that a configuration flag for the first application indicates that the first application allows tunnelling.

5. The method of claim 3, wherein establishing the tunnel comprises:
requesting, at a service running within a standards-compliant logic block, to provide an interface address for a controller program running in the secure element that corresponds to the second communication protocol; and
establishing the tunnel based on the interface address, wherein the command is wrapped in a payload corresponding to the second communication protocol.

6. The method of claim 1, wherein establishing the communication interface includes:
establishing a channel-less interface between the bridge interface and the first application, wherein forwarding the command to the first application over the communication interface includes forwarding the command via the channel-less interface.

7. The method of claim 6, further comprising verifying that a configuration flag for the first application indicates that the first application allows communication from a channel-less interface.

8. The method of claim 1, wherein the first communication protocol corresponds to one of contactless-type A, contactless-type B, contactless-type F, I2C_A, or I2C_B.

9. The method of claim 1, wherein the first communication protocol corresponds to one of Bluetooth, ultra-wideband, Wi-Fi, or NFC.

10. The method of claim 1, wherein the command corresponds to a ranging operation to determine a range between the first device and the second device.

11. A device comprising:
one or more processors; and
a non-transitory computer-readable memory storing instructions, configured to cause the one or more processors to:
establish a secure session with a second device via a secure element of the device, the secure session established via a first communication protocol;
receive, via the first communication protocol at a bridge interface in the secure element, a command directed to a first application in the secure element;
analyze the command to determine the first application and to determine a second communication protocol associated with the first application, wherein the second communication protocol is different from the first communication protocol;
establish a communication interface between the bridge interface and the first application; and
forward the command to the first application over the communication interface.

12. The method of claim 1, further comprising:
receiving a response from the first application at the bridge interface over the communication interface; and
forwarding the response to the second device over the first communication protocol.

13. The method of claim 1, wherein establishing the communication interface includes:
establishing a tunnel between the bridge interface and the first application, wherein the tunnel is configured to wrap the command based on the second communication protocol, wherein forwarding the command to the first application over the communication interface includes forwarding the command over the tunnel.

14. The method of claim 3, further comprising verifying that a configuration flag for the first application indicates that the first application allows tunnelling.

15. The method of claim 3, wherein establishing the tunnel comprises:
requesting, at a service running within a standards-compliant logic block, to provide an interface address for a controller program running in the secure element that corresponds to the second communication protocol; and
establishing the tunnel based on the interface address, wherein the command is wrapped in a payload corresponding to the second communication protocol.

16. The method of claim 1, wherein establishing the communication interface includes:
establishing a channel-less interface between the bridge interface and the first application, wherein forwarding the command to the first application over the communication interface includes forwarding the command via the channel-less interface.

17. The method of claim 6, further comprising verifying that a configuration flag for the first application indicates that the first application allows communication from a channel-less interface.

18. The method of claim 1, wherein the first communication protocol corresponds to one of contactless-type A, contactless-type B, contactless-type F, I2C_A, or I2C_B.

19. The method of claim 1, wherein the command corresponds to a ranging operation to determine a range between the first device and the second device.

20. A non-transitory computer-readable medium storing instructions thereon, which when executed by one or more processors, cause the one or more processors to perform operations comprising:
establishing, via a first device, a secure session with a second device via a secure element of the first device, the secure session established via a first communication protocol;
receiving, via the first communication protocol at a bridge interface in the secure element, a command directed to a first application in the secure element;
analyzing the command to determine the first application and to determine a second communication protocol associated with the first application, wherein the second communication protocol is different from the first communication protocol;
establishing a communication interface between the bridge interface and the first application; and
forwarding the command to the first application over the communication interface.
